(19) United States
(12) Patent Application Publication
(10) Pub. No.: US 2018/0245767 A1
(43) Pub. Date: Aug. 30, 2018

(54) HEADLIGHT EQUIPPED WITH HEATING WIRES

(71) Applicant: Gwang Young LEE, Seosan-si (KR)

(72) Inventor: Gwang Young LEE, Seosan-si (KR)

(21) Appl. No.: 15/787,932

(22) Filed: Oct. 19, 2017

(30) Foreign Application Priority Data
Feb. 28, 2017 (KR) 10-2017-0026637

(51) Int. Cl. F21S 8/10

(52) U.S. Cl. CPC F21S 48/34; F21S 48/33; F21S 48/1225

(57) ABSTRACT

Disclosed herein is a headlight equipped with heating wires, which is implemented such that transparent heating wires are disposed in the plastic of the headlight and the plastic of the headlight is heated through the generation of heat by the heating wires. The headlight equipped with heating wires includes: plastic configured to protect the headlight of a vehicle from external impact; and a plurality of heating wires disposed in connection with the plastic, and configured to be connected to the power supply of the vehicle and to receive power and generate heat when a switch is turned on.

### BACKGROUND

### 1. Technical Field

The present invention relates generally to a headlight equipped with heating wires, and more specifically to a headlight equipped with heating wires, which is implemented such that transparent heating wires are disposed in the plastic of the headlight and the plastic of the headlight is heated through the generation of heat by the heating wires.

### 2. Description of the Related Art

In order to remove frost or moisture generated on windshields, ice formed in winter, etc. during the running of a vehicle, an air conditioner or heater is used for a front windshield, and heating wires are applied onto a rear windshield at regular intervals so that when current is supplied, the heating wires generate heat and increase the temperature of the windshield coated with the heating wires, thereby removing frost, moisture, ice, or the like.

Korean Patent No. 10-0354094 (registered on Sep. 11, 2002) discloses a heating wire device for the rear windshield of a vehicle, which is installed to automatically operate in response to a change in ambient temperature around a vehicle. This heating wire device for the rear windshield of a vehicle includes: a power supply connected in series to heating wires; an ignition switch connected to the ignition device of a vehicle; a manual switch configured to manually and selectively open and close a heating wire circuit, and an automatic switch installed in parallel with the manual switch; an electromagnet configured to control the operation of the automatic switch; and a hot coil disposed in series with the electromagnet as a resistor. In this case, the electromagnet is disposed in parallel with the automatic switch, and is installed to allow the automatic switch to be closed by means of the magnetic force thereof when power is supplied to the electromagnet and to allow the automatic switch to be opened due the reduced magnetic force thereof when power is reduced. Furthermore, the hot coil has resistance varying with ambient temperature around the vehicle, and is configured such that the resistance thereof is increased when the ambient temperature is increased and is decreased when the ambient temperature is decreased. According to this disclosed technology, the operation of the vehicle heating wire device can be automatically controlled according to ambient temperature around a vehicle, and thus the convenience of a driver is improved.

Furthermore, Korean Patent No. 10-0290601 (registered on Mar. 5, 2001) discloses a heating wire device for removing frost from a vehicle, which can rapidly distribute power concentrated on the terminals of heating wires and can also increase resistance on the center portion of glass remote from the terminals, thereby uniformly melting and removing frost. This heating wire device for removing frost from a vehicle includes: terminals formed on the respective centers of root patterns formed along both sides of the rear windshield of a vehicle in a vertical direction; and heating patterns formed to connect the terminals with the root patterns across the rear windshield, and to have a gradual curvature so that the sectional areas thereof are reduced in a direction toward a top location above the center portion of the rear windshield.

The above-described conventional heating wire devices for a vehicle cannot be applied to the front windshield, side-view mirrors and headlight glass of a vehicle because the heating wires are made of an opaque material, such as nichrome wire. Accordingly, frost or moisture is removed using an air conditioner, a heater, or other heating means, and thus the above-described conventional heating wire devices for a vehicle are disadvantageous in that they cannot achieve a sufficient reduction in energy consumption.

### SUMMARY

The present invention has been conceived to overcome the above-described disadvantages, and an object of the present invention is to provide a headlight equipped with heating wires, which is implemented such that transparent heating wires are disposed in the plastic of the headlight and the plastic of the headlight is heated through the generation of heat by the heating wires.

In order to accomplish the above object, the present invention provides a headlight equipped with heating wires, including: plastic configured to protect the headlight of a vehicle from external impact; and a plurality of heating wires disposed in connection with the plastic, and configured to be connected to the power supply of the vehicle and to receive power and generate heat when a switch is turned on.

In an embodiment, the plastic may include holes configured to accommodate the heating wires.

In an embodiment, the heating wires may be disposed by adhering the heating wires on the surface of the plastic.

In an embodiment, the headlight may further include waterproof coating paper adhered onto the surface of the plastic and configured to waterproof the surface of the plastic.

In an embodiment, the heating wires may be formed using thin film patterns made of one of ITO, IZO, and ZnO.

In an embodiment, the heating wires may be formed using transparent electrode films made of In2O3:Sn.

In an embodiment, the heating wires may have a width in the range of 10 to 60 μm, and the interval between the heating wires may be 1 mm or more.

In an embodiment, the plastic may include concave lenses coupled to the inner surface thereof at locations opposite to the heating wires and configured to refract light from light from the headlight.

In an embodiment, the headlight may further include: a plurality of pieces of transparent paper disposed up to a height identical to that of the heating wires in spaces between the heating wires, and configured to pass light from the headlight of the vehicle therethrough; and a plurality of pieces of both-sided coated paper disposed between the plastic and the plurality of pieces of transparent paper and between the plastic and the heating wires, and configured to adhere the plastic and the plurality of pieces of transparent paper onto each other and also adhere the plastic and the heating wires onto each other.

In an embodiment, the headlight may further include a plurality of headlight heating wires attached onto the inside or outside of a headlight cap for protecting the headlight, and configured to be connected to the power supply of the vehicle and to receive power and generate heat when the switch is turned.

In an embodiment, there is provided a headlight equipped with heating wires, including inner plastic configured to protect the headlight of a vehicle from external impact; outer plastic adhered onto the inner plastic, and configured to protect the headlight of the vehicle from external impact; and a plurality of heating wires disposed between the inner plastic and the outer plastic, and configured to be connected to the power supply of the vehicle and to receive power and generate heat when a switch is turned on.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating a headlight equipped with heating wires according to a first embodiment of the present invention;

FIG. 2 is a view illustrating a headlight equipped with heating wires according to a second embodiment of the present invention;

FIG. 3 is a view illustrating a first example of the heating wires of FIG. 2;

FIG. 4 is a view illustrating a second example of the heating wires of FIG. 2;

FIG. 5 is a view illustrating the plastic of FIG. 2;

FIG. 6 is a view illustrating a headlight equipped with heating wires according to a third embodiment of the present invention;

FIG. 7 is a view illustrating a headlight equipped with heating wires according to a fourth embodiment of the present invention; and

FIG. 8 is a view illustrating a headlight equipped with heating wires according to a fifth embodiment of the present invention.

### DETAILED DESCRIPTION

Embodiments of the present invention will be described in detail with reference to the accompanying drawings so that those having ordinary knowledge in the art to which the present invention pertains can easily practice the present invention. The description of the present invention provides merely embodiments for structural and functional illustration, and thus the scope of the present invention should not be construed as being limited by these embodiments. In other words, since the present invention may be variously modified and have various embodiments, the scope of the present invention should be understood as including equivalents by which the spirit of the present invention can be achieved. Furthermore, the objects or effects proposed herein do not mean that specific embodiments include all of them or only the effects, and thus the scope of the present invention should not be construed as being limited thereto.

The meanings of the terms used herein should be understood as follows.

The terms “first,” “second,” etc. are each used to distinguish one component from another component, and the range of rights should not be limited by these terms. For example, a first component may be termed a second component, and, in a similar way, a second component may be termed a first component. It should be understood that when one component is described being “connected to” another component, it may be connected directly to the other component or may be connected to the other component with the other component intervening therebetween. In contrast, it should be understood that when one component is described as being “connected directly to” another component, it may be connected to the other component without the other component intervening therebetween. Furthermore, other expressions describing the relationships of components, i.e., “between” and “directly between,” or “close to” and “directly close to” should be understood in the same way.

A singular description includes a plural description unless otherwise defined. In the present specification and the attached clams, it should be appreciated that the terms “include,” “comprise,” “have” and their derivatives are intended to designate the presence of features, numbers, steps, operations, components, parts or combinations thereof described in the specification or the attached claims, but are not intended to exclude the possibility of presence or addition of one or more other features, numbers, steps, operations, components, parts, or combinations thereof in advance.

Unless otherwise defined, all the terms used herein, including technical or scientific terms, have the same meanings as understood by those having ordinary knowledge in the technical field to which the present invention pertains. The terms commonly used and defined in dictionaries should be interpreted as having meanings identical to those specified in the context of related technology. Unless definitely defined in the present specification, the terms should not be interpreted as having ideal or excessively formative meanings.

Headlights equipped with heating wires according to an embodiment of the present invention will be described in detail below with reference to the accompanying drawings.

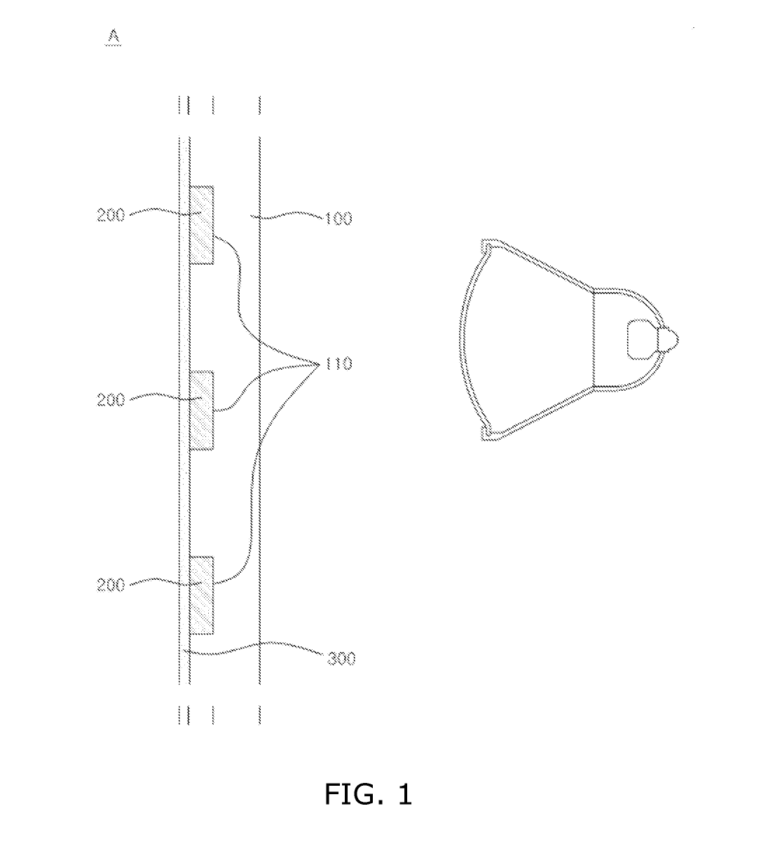

FIG. 1 is a view illustrating a headlight A equipped with heating wires according to a first embodiment of the present invention.

Referring to FIG. 1, the headlight A equipped with heating wires includes plastic 100, and a plurality of heating wires 200.

The plastic 100 is configured such that the plurality of heating wires 200 is inserted thereinto, and protects the headlight of a vehicle from external impact.

In an embodiment, the plastic 100 may include holes 110 configured to accommodate the heating wires 200.

The heating wires 200 are inserted into the holes 110 of the plastic 100, and are connected to the power supply of the vehicle. When a switch is turned on, the heating wires 200 receive power and generate heat, thereby adjusting the surface temperature of the plastic 100 and thus removing the moisture or frost of the plastic 100. Accordingly, the heating wires 200 can improve the transparency of the plastic 100, thereby improving the illuminance of the headlight A.

In an embodiment, the heating wires 200 may have the same length as the holes 110, and thus the surface of the plastic 100 may become flat after the heating wires 200 have been inserted into the holes 110.

The headlight A equipped with heating wire, which is configured as described above, further includes waterproof coating paper 300.

The waterproof coating paper 300 is adhered onto the surfaces of the plastic 100 and the heating wires 200, and waterproofs the surfaces of the plastic 100 and the heating wires 200.

In an embodiment, the waterproof coating paper 300 may be formed on the surfaces of the plastic 100 and the heating wires 200 by applying a material, such as low-molecular weight water-repellent silicon, volatile silicon, or the like, onto the surfaces of the plastic 100 and the heating wires 200.

The headlight A equipped with heating wires, which has the above-described features, is formed by inserting or attaching the transparent heating wires 200 having high light transparency into or onto the headlight plastic 100. The headlight plastic 100 is heated through the generation of heat by the heating wires 200 at the same time that the light from the headlight is transmitted through the plastic 100, and thus frost or moisture inside the headlight A can be removed, thereby improving the illuminance of the headlight A.

The headlight A equipped with heating wires, which has the above-described features, does not require the installation of an additional device configured to remove frost or moisture inside the headlight, thereby reducing the manufacturing cost and facilitating the manufacture of the headlight.

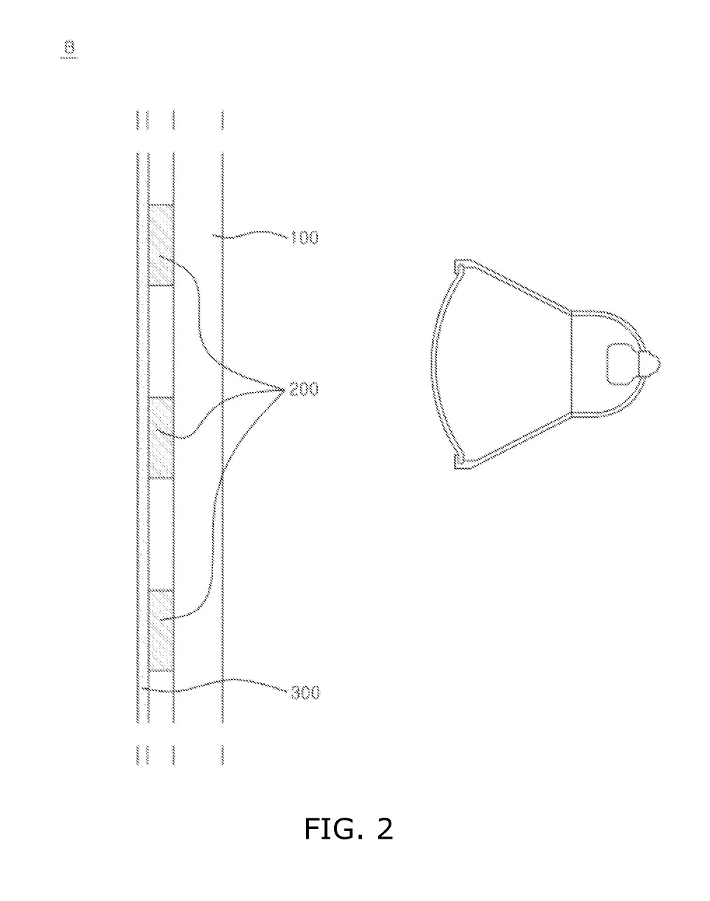

FIG. 2 is a view illustrating a headlight B equipped with heating wires according a second embodiment of the present invention.

Referring to FIG. 2, the headlight B equipped with heating wires includes plastic 100, a plurality of heating wires 200, and waterproof coating paper 300. For ease of description, descriptions of components identical to those of FIG. 1 will be omitted, and only different components will be described below.

The plastic 100 is configured such that heating wires 200 are adhered onto the surface thereof, and protects the headlight B of a vehicle from external impact.

The heating wires 200 are adhered onto the surface of the plastic 100, and are connected to the power supply of the vehicle. When a switch is turned on, the heating wires 200 receive power and generate heat, thereby adjusting the surface temperature of the plastic 100 and thus removing the moisture or frost of the plastic 100. Accordingly, the heating wires 200 can improve the transparency of the plastic 100, thereby improving the illuminance of the headlight B.

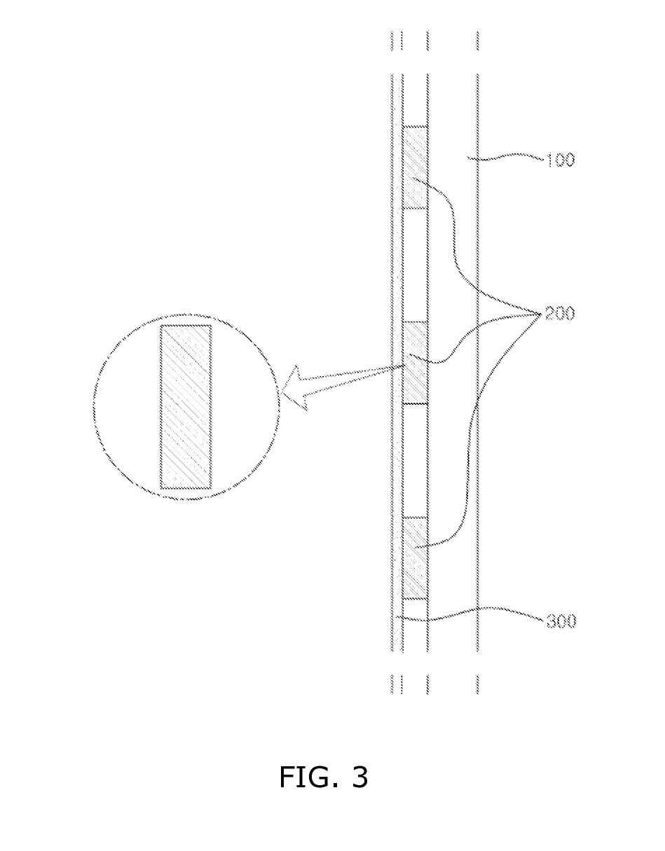

FIG. 3 is a view illustrating a first example of the heating wires of FIG. 2.

Referring to FIG. 3, the heating wires 200 may be formed using thin film patterns made of a material, such as Indium Tin Oxide (ITO), IZO, ZnO, or the like. The heating wires 200 may be formed by depositing such a material on the surface of the plastic 100 or by printing such a material on the surface of the plastic 100 via a printer. Since the thin film patterns made of a material, such as ITO, IZO, ZnO, or the like, are transparent and conductive, they are appropriate for use in the plastic 100 of the vehicle headlight.

In an embodiment, the heating wires 200 may be formed such that thin film patterns formed on the plastic 100 have one of various patterns, such as a diagonal pattern, a vertical pattern, a lateral pattern, a mesh pattern, etc.

In an embodiment, the heating wires 200 may have a width in the range of 10 to 60 μm, preferably in the range of 20 to 30 μm, which may not be seen with the naked eye.

In an embodiment, the heating wires 200 may have an interval of 1 mm or more, preferably in the range of 3 to 5 mm, which prevents light from being blurred when the headlight emits the light.

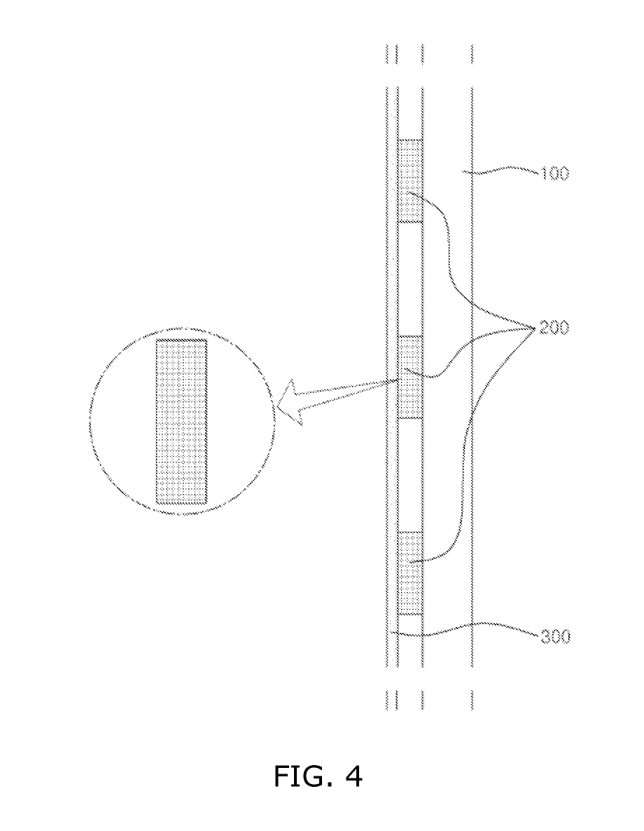

FIG. 4 is a view illustrating a second example of the heating wires of FIG. 2.

Referring to FIG. 4, heating wires 200 may be formed using transparent electrode films made of In2O3:Sn, and may be adhered onto the surface of plastic 100. In this case, In2O3:Sn may be produced by adding Sn to In2O3. Since In2O3:Sn is transparent and high light transparency, it is appropriate for use in the plastic 100 of the vehicle headlight.

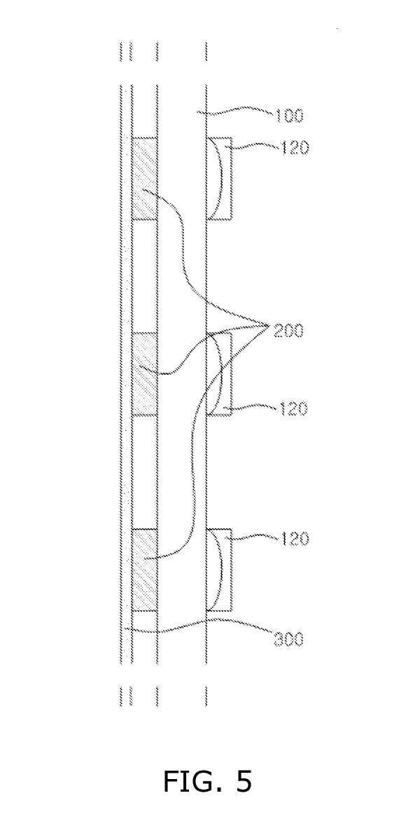

FIG. 5 is a view illustrating the plastic 100 of FIG. 2.

Referring to FIG. 5, the plastic 100 may include concave lenses 120.

The concave lenses 120 are coupled onto the inner surface of the plastic 100 at locations opposite to the heating wires 200. The concave lenses 120 refract light from a headlight and thus make the refractive index of light, transmitted through the heating wires 200 attached onto the surface of the plastic 100, and the refractive index of light, transmitted through the plastic 100, similar to each other, thereby preventing the light from being scattered and also preventing a difference in the color of the light from occurring.

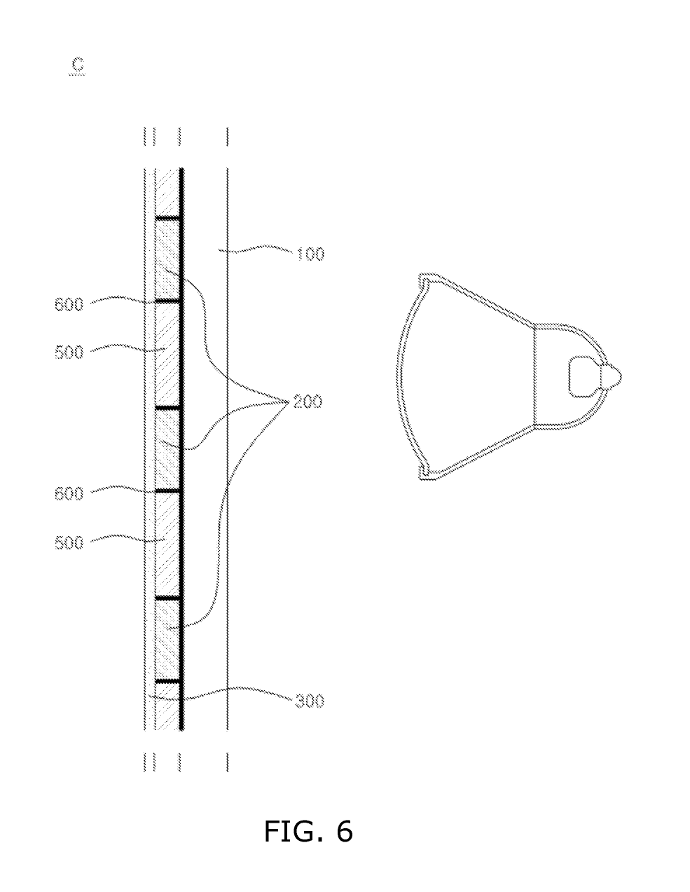

FIG. 6 is a view illustrating a headlight C equipped with heating wires according to a third embodiment of the present invention.

Referring to FIG. 6, the headlight C equipped with heating wires includes plastic 100, a plurality of heating wires 200, waterproof coating paper 300, a plurality of pieces of transparent paper 500, and a plurality of pieces of double-sided coated paper 600. For ease of description, descriptions of components identical to those of FIG. 2 will be omitted, and only different components will be described below.

The waterproof coating paper 300 is adhered onto the surfaces of the plastic 100, the heating wires 200, and the transparent paper 500, and waterproofs the surfaces of the plastic 100, the heating wires 200, and the transparent paper 500.

In an embodiment, the waterproof coating paper 300 may be formed on the surfaces of the plastic 100, the heating wires 200, and the transparent paper 500 by applying a material, such as low-molecular weight water-repellent silicon, volatile silicon, or the like, onto the surfaces of the plastic 100, the heating wires 200, and the transparent paper 500.

The plurality of pieces of transparent paper 500 is formed up to a length identical to that of the heating wires 200 in spaces between the heating wires 200, and transmits light from the headlight of a vehicle therethrough.

The plurality of pieces of double-sided coated paper 600 is disposed not only between the plastic 100 and the plurality of pieces of transparent paper 500 but also between the plastic 100 and the heating wires 200. The plurality of pieces of double-sided coated paper 600 adheres the plastic 100 and the plurality of pieces of transparent paper 500 to each other, and also adheres the plastic 100 and the heating wires 200 to each other.

In an embodiment, the plurality of pieces of double-sided coated paper 600 may be further disposed between the heating wires 200 and the plurality of pieces of transparent papers 500, and may further adhere the heating wires 200 and the plurality of pieces of transparent paper 500 to each other.

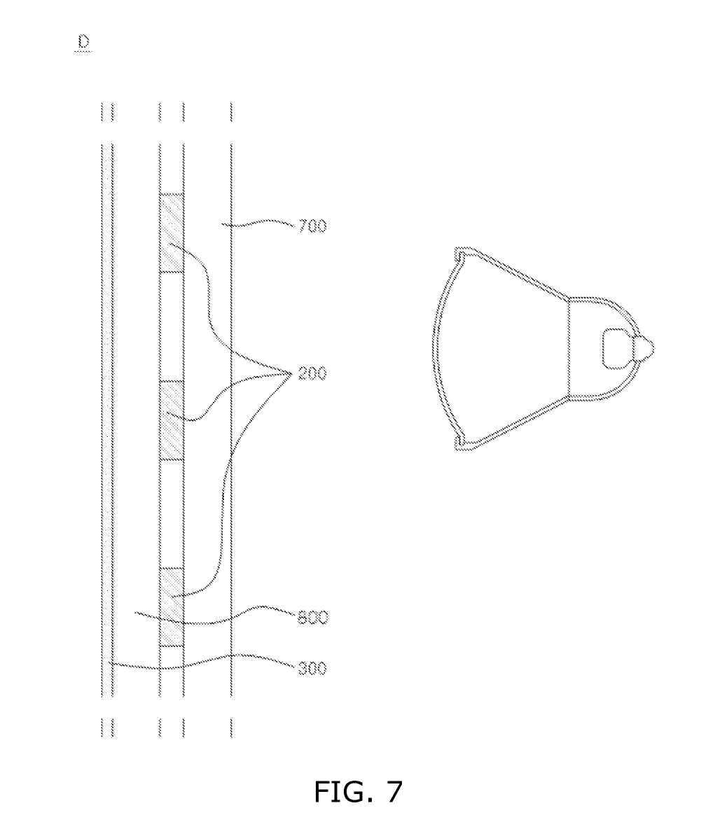

FIG. 7 is a view illustrating a headlight D equipped with heating wires according to a fourth embodiment of the present invention.

Referring to FIG. 7, the headlight D equipped with heating wires includes inner plastic 700, outer plastic 800, and a plurality of heating wires 200.

The inner plastic 700 is adhered onto the outer plastic 800, and protects the headlight of a vehicle from external impact.

The outer plastic 800 is adhered onto the inner plastic 700, and protects the headlight of the vehicle from external impact.

The heating wires 200 are adhered between the inner plastic 700 and the outer plastic 800, and are connected to the power supply of the vehicle. When a switch is turned on, the heating wires 200 receive power and generate heat, thereby adjusting the surface temperature of the surface temperatures of the inner plastic 700 and the outer plastic 800 and thus removing the moisture or frost of the inner plastic 700 and the outer plastic 800. Accordingly, the heating wires 200 can improve the transparency of the inner plastic 700 and the outer plastic 800, thereby improving the illuminance of the headlight D.

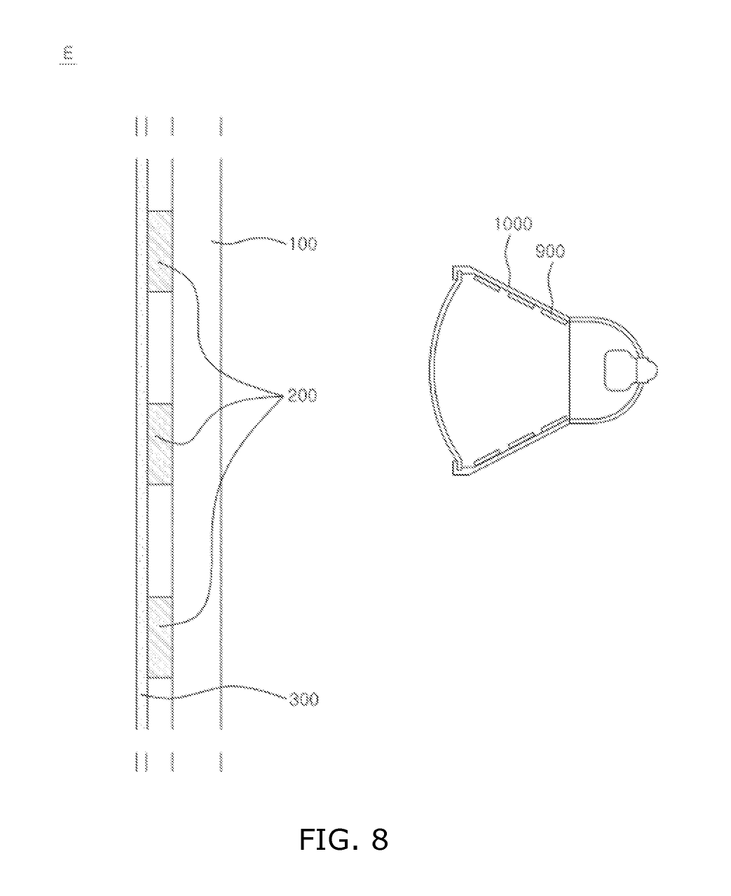

FIG. 8 is a view illustrating a headlight E equipped with heating wires according to a fifth embodiment of the present invention.

Referring to FIG. 8, the headlight E equipped with heating wires includes plastic 100, a plurality of heating wires 200, waterproof coating paper 300, and a plurality of headlight heating wires 900. For ease of description, descriptions of components identical to those of FIG. 2 will be omitted, and only different components will be described below.

The headlight heating wires 900 are adhered onto the inner or outer side of a headlight cap 1000 configured to protect the headlight E and to transmit light from the headlight E in a rectilinear propagation direction by reflecting the light, and are connected to the power supply of a vehicle. When a switch is turned on, the headlight heating wires 900 receive power and generate heat, thereby adjusting the temperature of an inner space and thus removing the moisture or frost of the plastic 100. Accordingly, the heating wires 900 can improve the transparency of the plastic 100, thereby improving the illuminance of the headlight E.

In an embodiment, the headlight heating wires 900 may be formed using thin film patterns made of a material, such as nichrome wire, ITO, IZO, ZnO, or the like.

According to the present invention, there is provided the headlight equipped with heating wires, which is implemented such that the transparent heating wires are disposed in the plastic of the headlight and the plastic of the headlight is heated through the generation of heat by the heating wires, and thus the transparent heating wires having high light transparency are inserted or attached into or onto the headlight plastic, with the result that the headlight plastic is heated through the generation of heat by the heating wires at the same time that the light from the headlight is transmitted through the plastic, thereby enabling frost or moisture inside the headlight to be removed and thus improving the illuminance of the headlight.

According to the present invention, the headlight equipped with heating wires is provided, and thus the installation of an additional device configured to remove frost or moisture inside the headlight is not required, thereby reducing the manufacturing cost and facilitating the manufacture of the headlight.

The above-described embodiments of the present invention are not necessarily implemented via the above-described devices and/or methods, but may be implemented via a program configured to implements functions corresponding to the components of the embodiments of the present invention, or via a storage media having the program stored thereon. This implementation may be easily performed by those skilled in the art based on the foregoing description of the embodiments. While the embodiments of the present invention have been described in detail, the range of rights of the present invention is not limited to the embodiments and various modifications and alterations made using the basic concept of the present invention defined in the attached claims by those skilled in the art fall within the range of rights of the present invention.

What is claimed is:

1. A headlight equipped with heating wires, comprising:
plastic configured to protect the headlight of a vehicle from external impact; and
a plurality of heating wires disposed in connection with the plastic, and configured to be connected to a power supply of the vehicle and to receive power and generate heat when a switch is turned on;
wherein the plastic comprises concave lenses coupled to an inner surface of the plastic at locations opposite to the heating wires, and configured to refract light from the headlight.

2. The headlight of claim 1, wherein the plastic further comprises holes configured to accommodate the heating wires.

3. The headlight of claim 1, wherein the heating wires are disposed by adhering the heating wires on a surface of the plastic.

4. The headlight of claim 1, further comprising waterproof coating paper adhered onto the surface of the plastic and configured to waterproof the surface of the plastic.

5. The headlight of claim 1, wherein the heating wires are formed using thin film patterns made of one of ITO, IZO, and ZnO.

6. The headlight of claim 1, wherein the heating wires are formed using transparent electrode films made of In2O3:Sn.

7. The headlight of claim 1, wherein the heating wires have a width in a range of 10 to 60 μm, and an interval between the heating wires is 1 mm or more.

8. The headlight of claim 3, further comprising:
a plurality of pieces of transparent paper disposed to a height identical to that of the heating wires in spaces between the heating wires, and configured to pass light from the headlight of the vehicle therethrough; and
a plurality of pieces of both-sided coated paper disposed between the plastic and the plurality of pieces of transparent paper and between the plastic and the heating wires, and configured to adhere the plastic and the plurality of pieces of transparent paper onto each other and also adhere the plastic and the heating wires onto each other.

9. The headlight of claim 1, further comprising a plurality of headlight heating wires attached onto an inside or outside of a headlight cap configured to protect the headlight, and configured to be connected to the power supply of the vehicle and to receive power and generate heat when the switch is turned.
